(19) United States
(12) Patent Application Publication
(10) Pub. No.: US 2014/0324443 A1
(43) Pub. Date: Oct. 30, 2014

(54) Health Scoring Systems and Methods

(71) Applicants: Nathan W. Ricks, Lehi, UT (US); Dustin Bybee, Lehi, UT (US); Caleb Manscill, Lehi, UT (US)

(72) Inventors: Nathan W. Ricks, Lehi, UT (US); Dustin Bybee, Lehi, UT (US); Caleb Manscill, Lehi, UT (US)

(21) Appl. No.: 13/871,947

(22) Filed: Apr. 26, 2013

(51) Int. Cl. G06F 19/00

(52) U.S. Cl. CPC G06F 19/3431
USPC 705/2

(57) ABSTRACT

A method for scoring an individual's overall health and wellness is disclosed. The method includes the steps of receiving one or more health measurements of an individual. The one or more health measurements can include the individual's resting heart rate, the individual's blood pressure, and the individual's body fat percentage. Next, a health score of the individual is calculated based on the receive health measurements.

### CROSS-REFERENCE TO RELATED APPLICATIONS

This application claims benefit to U.S. Provisional Patent Application Ser. No. 61/638,914 filed Apr. 26, 2013

### BACKGROUND

1. Field of the Invention

The present invention relates generally to the field of health measurement and scoring systems and methods. More specifically, this invention relates to a health measurement system for providing an overall score or grade of the individual's health and wellness. Specifically, some implementations of the scoring system factor one or more of an individual's weight, body fat percentage, heart rate, blood pressure, and physical abilities.

2. Background

The benefits of managing one's weight, eating properly, and maintaining an active lifestyle are well known and researched. These benefits include a lower propensity to illness and disease and a prolonged life expectancy. Despite these advantages, the general population is experiencing an increase in body weight and a decline in many aspects of its health. One potential cause of this trend is lack of reliable feedback available to specific individuals about various aspects of their health. For instance, while many people understand the need for healthy habits, they often do not recognize the effect of their various daily lifestyle choices and unhealthy habits. Instead, other priorities can divert an individual's focus from health to other cares. As a result, well-intentioned individuals may unintentionally become heavier and less healthy.

To address these challenges, hundreds of fad diets and weight-loss plans promise quick and easy weight loss and good health. These programs try to make weight loss and good health easier, quicker, cheaper, more reliable, and less painful. While these programs can be effective and beneficial, they are often short lived and do not promote long-term health and wellness. These programs can also take an individual's focus off the more fundamental and essential elements of health and wellness, including healthy eating habits, exercise, and physical activity.

Additionally, because many health problems develop over long periods, some people are unaware of the negative effects of their lifestyle choices. For instance, because many individuals feel good or are content with their overall appearance and body weight they fail to recognize or addressing their unhealthy lifestyle practices. These individuals may later experience serious health problems that they may have avoided if they had understood their effects of their lifestyle choices or if they had been advised or their potential for illness and advised to make preventative changes.

Thus, while current health programs and systems are available, improvements would be desirable.

### SUMMARY

The present invention relates generally to the field of health measurement and scoring systems and methods. More specifically, this invention relates to a health measurement system for providing an overall score or grade of the individual's health and wellness. The overall health score can give an individual a general sense of his/her overall health. This score can have a significant impact on individuals who considers themselves healthy, but receives a lower score that anticipated. The score can also provide significant motivation to users aspiring to improve their overall health. For instance, when individuals finally achieve a higher overall health score, individuals can have a sense of accomplishment that propels them to continue their improvement.

Specifically, some implementations of the scoring system provide an overall health score as an average of scores given to an individual based on their various health measurements. The overall health score can be given based a set of hierarchical scores, such as, for example, the grades A through F or the numbers one through five. In some implementations, the overall health score can be an average of a large body of individual measurements, including, but not limited to, heath measurements relating to a user's fitness, blood content, weight and fat percentage, flexibility, heart health, and/or lung capacity.

Other aspects of the invention relate generally to the field of health measurement systems and methods. More specifically, the invention relates to a health measurement system, that measures various aspects of an individual's personal health and wellness. The health measurement system can include a body scale that measures a user's body weight and body mass index or body fat percentage. This information can be transmitted across a wireless communications link to a network device that processes the information and provides the user with analytics, advice, encouragement, or other such information via a website or mobile application. The wireless communications link can utilize 3G, GSM, CDMA, or another such wireless communications standard.

Additionally, in some implementations, additional health measurements are acquired by the health measurement system, such as the user's blood pressure, body temperature, glucose levels, C-reactive protein, ketone levels, oxygen saturation levels, cholesterol levels, testosterone levels, progesterone levels, alcohol levels, drug levels, and more. Using this information the health measurement system can recognize health risks and warnings and educate the user about potential health risks. For instance, based on the user's measured heart rate, the health measurement system can identify irregularities, such as arrhythmia, bradycardia, or atrial fibrillation. These additional health measurements can be acquired via the body scale or via a separate body attachment.

The separate body attachment device can be worn or carried by the user. The body attachment device can include an anklet, bracelet, clip, finger ring, toe ring, pendant, necklace, or earring or other piercing. Additionally, the separate body attachment device can be implanted in or below the epidermis of the user. The separate body attachment device can include one or more measurement devices for measuring any of the above-mentioned health measurements. For example, the separate body attachment device can measure the user's blood pressure, body temperature, as well as the user's physical activity, movement, and calorie expenditures. These health measurements can be transmitted over a communications link (e.g., a Bluetooth connection) to the body scale, which can process this information and communicate it to the network device.

As mentioned, in some implementations, the user can access these health measurements as well as analytics, graphs, and other information via a website or mobile application. The website and mobile application can access information from the network device and provide this information to the user in an easy-to-understand form. Additionally, the website or mobile application can provide various other forms of health-related information, tools, logs, charts, advice, and warnings. In some instances, the network device can be configured to relay the health measurements to a health professional, health insurance organization, physical trainer, or other third party.

The measurement and presentation of the user's health measurements and information can provide the user with information tools that can assist the user to manage his/her weight and overall health. This system can avoid the downsides of temporary health fads by offering actual, measurable information that can be used to form enduring, effective, and improved lifestyle changes. This information can empower the user to managing his/her weight, eat properly, and maintaining an active lifestyle in order to reduce his/her propensity to illness and disease and prolong his/her life expectancy.

These and other features and advantages of the present invention may be incorporated into certain embodiments of the invention and will become more fully apparent from the following description and appended claims, or may be learned by the practice of the invention as set forth hereinafter. The present invention does not require that all the advantageous features and all the advantages described herein be incorporated into every embodiment of the invention.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings.

FIG. 1 illustrates a representative health measurement system, according to some embodiments of the present invention.

FIG. 2 illustrates a representative system for implementing embodiments of the invention.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The following disclosure of the present invention is grouped into subheadings. The utilization of the subheadings is for convenience of the reader only and is not to be construed as limiting in any sense.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).”

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” “in some configurations,” or “in some instances,” which may each refer to one or more of the same or different embodiments. Furthermore, the terms “comprising,” “including,” “having,” and the like, as used with respect to embodiments of the present invention, are synonymous with the definition afforded the term “comprising.”

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical or electrical contact. However, “coupled” may also mean that two or more elements are not in direct contact with each other, but yet still cooperate or interact with each other.

The present invention relates generally to the field of health measurement systems and methods. More specifically, the invention relates to a health measurement system that can measure various aspects of an individual's personal health and wellness.

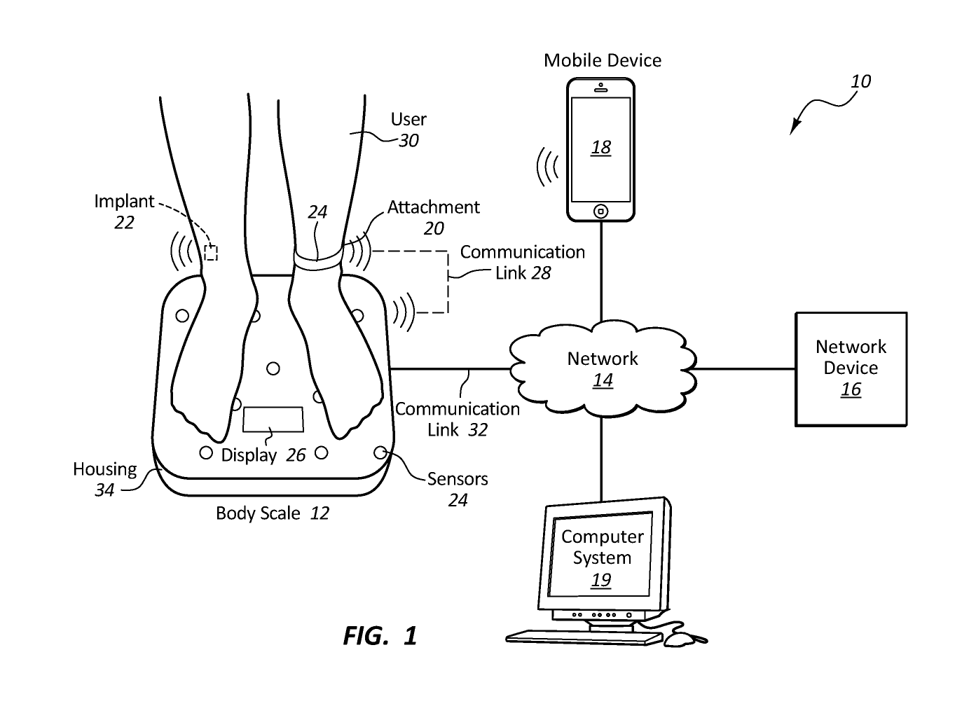

Reference will now be made to FIG. 1, which illustrates a representative health measurement system 100, according to some embodiments. The health measurement system 100 can generally includes a body scale 12, a communications network 14, a network device 16 (e.g., a server, a server system, a computer system, etc.), and optionally a mobile device 18 or computer system 19 and/or a separate body attachment (e.g., the illustrated anklet) 20 or an implant 22. The health measurement system 100 can measure and provide health and wellness measurements and information to a user 30. This information can be provided, at least in part, by a body scale 12. When a user stands on the top surface of the body scale 12, the body scale 12 can measure various aspects of the user's body and health. For example, the body scale 12 can measure body the user's body weight, body mass index or body fat percentage, and/or other health measurements. These health measurements can be made using one or more sensor or measuring devices (herein sensors) disposed on or within a housing 34 of the body scale 34.

Additionally, in some implementations, additional health measurements are acquired by the health measurement system 10, such as the user's blood pressure, body temperature, glucose levels, C-reactive protein, ketone levels, oxygen saturation levels, cholesterol levels, testosterone levels, progesterone levels, alcohol levels, drug levels, and more. Using this information the health measurement system 10 can recognize health risks and warnings and educate the user about potential health risks. For instance, based on the user's measured heart rate, the health measurement system 10 can identify irregularities, such as arrhythmia, bradycardia, or atrial fibrillation. These additional health measurements can be acquired via the body scale 12 or via a separate body attachment device (or simply “body attachment”) 20.

The body attachment 20 can be worn or carried by the user. As shown, the body attachment 20 is an anklet. In other embodiments, the body attachment 20 can be a bracelet, clip, finger ring, toe ring, pendant, necklace, earring or other piercing. Additionally, the body attachment 20 can be in the form of an implant 22 that is placed in or below the epidermis of the user 30. The body attachment 20 can include one or more measurement devices for measuring any of the above-mentioned health measurements. For example, in some embodiments, the body attachment 20 can measure the user's blood pressure, body temperature, as well as the user's physical activity, movement, and calorie expenditures. These health measurements can be transmitted over a communications link 28 (e.g., a wired link or a short-range wireless link, such as a Bluetooth link) to the body scale 12.

Health measurements can be transmitted by the body scale 12 across a communications link 32, over a communications network 14, to a network device 16. The network device 16 can be a server, a database, and/or other such network devices. The network device 16 can processes and/or analyze the health measurements and provide the user with analytics, advice, encouragement, or other such information via a website or mobile application, which can be accessed via a mobile device 18 (e.g., a mobile phone or tablet computer) or a computer system 19 (e.g., a personal computer, laptop, etc.) For examples, the user's weight, body mass index, blood pressure, body temperature, blood glucose levels, C-reactive protein, ketone levels, oxygen saturation, blood cholesterol levels, testosterone levels, and/or progesterone levels can be accessed through an Internet website and/or a mobile application. The network device 16 can also provide other health related information and services to the user 30. For example, messages, analytics, suggestions, and educational information and services can be provided along with the health measurements. In some embodiments, the health measurement system 10 can compile the user's measurement information and/or additional information and provide the user with an overall health score. In some instance, health-related information and/or health measurements can additionally or alternatively be accessed with the body scale 12.

Each of the respective components of the health measurement system 10 will be described in detail in the sections presented below.

### Body Scale

Specific reference will now be made to the body scale 12 of FIG. 1. As mentioned, the body scale 12 can be configured to take and process measurements, receive measurements from the body attachment 20 or implant 22, and/or transmit information to a network device 16. In some instances, the body scale 12 can functions as both a bathroom scale and serve as a base station that receive and/or transmits health measurements. Generally, the various components of the body scale 12 can be included within a housing 34. The housing 34 can be made of a plastic, metal, glass, composite, or other suitable materials. The housing 34 can contain or support one or more sensors or measuring devices 24, a mass controller, a memory device, a storage device, a display 26, and other such components. In some instances, housing 34 can also contain an internal power source, such as a battery. In other instances, the body scale 12 can acquire power from an external power supply, such as a wall power outlet, to power the body scale 12 or charge the internal power source.

The body scale 12 can acquire health measurements using one or more or other measuring devices 24. Various measurement components can be utilized by the body scale 12, as are discussed in the Health Measurements section below. For example, the body scale 12 can include a weight sensor configured to measure the user's weight when the user 30 stands on the body scale 12.

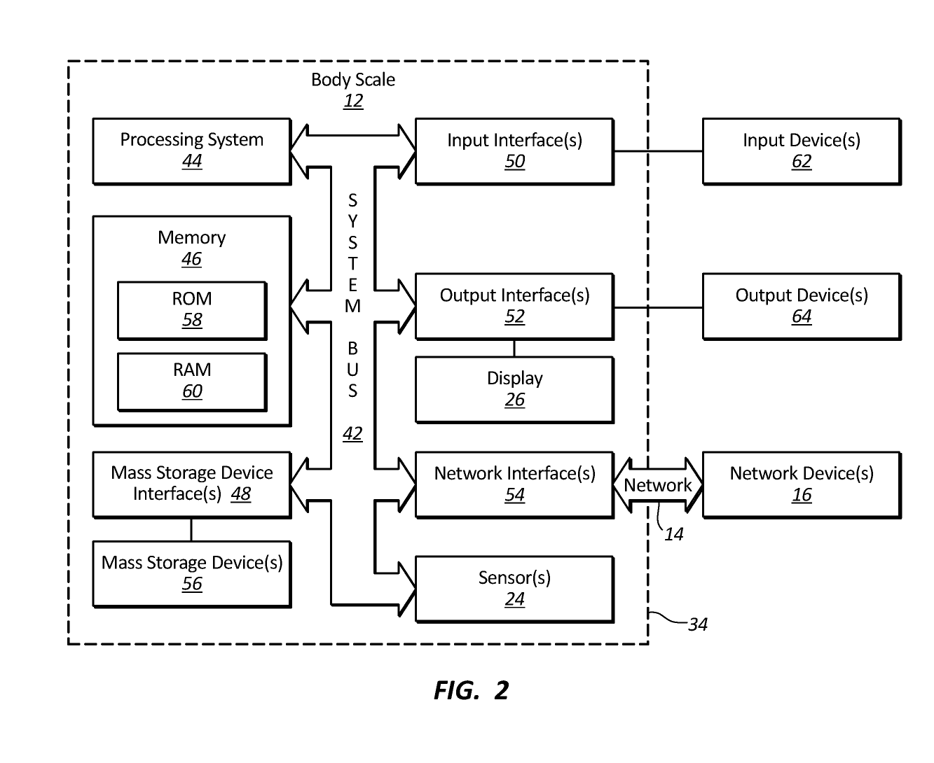

Reference will now be made to FIG. 2, which illustrates a representative operating environment in which embodiments of the body scale 12 may be implemented. Embodiments of the body scale 12 may be practiced by one or more computing devices and in a variety of system configurations. For examples, the body scale 12 can include one or more embedded systems with general purpose processing units, digital/media signal processors (DSP/MSP), application specific integrated circuits (ASIC), stand alone electronic devices, and other such electronic environments.

Embodiments of the body scale 12 can embrace one or more computer-readable media, wherein each medium may be configured to include or includes thereon data or computer executable instructions for calculating body measurement and processing health measurement data. The computer executable instructions can include data structures, objects, programs, routines, or other program modules that may be accessed by a controller 44, for performing body measurement calculations and other identified functions. Computer executable instructions cause the controller 44 to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”) 60, read-only memory (“ROM”) 58, programmable read-only memory (“PROM”), erasable programmable read-only memory (“EPROM”), electrically erasable programmable read-only memory (“EEPROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

As shown in FIG. 2, a representative body scale 12 can includes system bus 42, which may be configured to connect various components thereof and enables data to be exchanged between two or more components. System bus 42 may include one of a variety of bus structures including a memory bus or memory controller, a peripheral bus, or a local bus that uses any of a variety of bus architectures. Typical components connected by system bus 42 include controller 44 and one or more sensors 24. Other components of the body scale 12 can include one or more mass storage device interfaces 48, input interfaces 50, output interfaces 52, and/or network interfaces 54, each of which will be discussed below.

The controller 44 can includes one or more processors, such as a central processor and optionally one or more other processors designed to perform a particular function or task. For example, the controller 44 can be configured to process body measurement data and identify health measurements, potential illnesses, symptoms, or diseases. The controller 44 can also be configured to identify trends in the user's health measurements and present these trends to the user. The controller 44 can also be configured to prepare data measurements for transmission to a network device 16 and process received data from the network device 16. Generally, the controller 44 can execute instructions provided on computer-readable media, such as on memory 46, a magnetic hard disk, a removable magnetic disk, a magnetic cassette, an optical disk, or from a communication connection, which may also be viewed as a computer-readable medium.

The memory 46 includes one or more computer-readable media that may be configured to include or includes thereon data or instructions for manipulating data, and may be accessed by controller 44 through system bus 42. Memory 46 may include, for example, ROM 58, used to permanently store information, and/or RAM 60, used to temporarily store information.

One or more mass storage device interfaces 18 may be used to connect one or more mass storage devices 56 to system bus 42. Various types of data can be stored in the mass storage devices 56, such as a user's name, weight measurement history, other body measurement history, user's height, user's ages, and other demographic and personal information. This information can be used by the controller 44 to identify trends, calculate health measurements (e.g. using body height to calculate body mass index) and to identify potential health risks or symptoms. The mass storage devices 56 may be incorporated into or may be peripheral to the body scale 12 and allow the body scale 12 to retain large amounts of data. Examples of mass storage devices include hard disk drives, solid state storage memory, and flash memory. Mass storage devices 56 and their corresponding computer-readable media provide nonvolatile storage of data and/or executable instructions that may include one or more program modules such as an operating system, one or more application programs, other program modules, or program data. Such executable instructions are examples of program code means for implementing the functions of the body scale 12 disclosed herein.

One or more input interfaces 50 may be employed to enable a user to enter data and/or instructions to the body scale 12 through one or more corresponding input devices 62. Examples of such input devices include a keyboard, touch screen, or buttons. In some embodiments, the input devices 62 are coupled to and/or incorporated into the body scale 12. Similarly, examples of input interfaces 50 that may be used to connect the input devices 62 to the system bus 42 include a serial port, a parallel port, a universal serial bus (“USB”), an integrated circuit, or another interface. For example, in some configurations, the body attachment 20 is electronically coupled to the body scale 12 through an input interfaces 50.

One or more output interfaces 52 may be employed to connect one or more corresponding output devices 64 to system bus 42. Examples of output devices 64 include a monitor or display screen, a speaker, and the like. A particular output device 34 may be integrated with or peripheral to body scale 12. Examples of output interfaces include a video adapter, an audio adapter, a parallel port, and the like.

A display 26 (such as that shown in FIG. 1) can be one representative output device provided by the body scale 12 to present various types of information to the user. For example, the display 26 can display health measurements, such as a body weight, body fat percentage, or other health measurements included in the Health measurements section below. The display 26 can include a touch screen, thus serving the dual function of an input device and an output device.

One or more network interfaces 54 can enable the body scale 12 to exchange information with one or more network devices 16 and/or a body attachment 20. In some embodiments, the body scale 12 includes a first network interface 54 for communicating via a network 14 to one or more network devices 16. The communication link (e.g., link 32 of FIG. 1) that may include hardwired and/or wireless links 32. Examples of network interfaces include a network adapter for connection to a local area network (“LAN”) or a modem, wireless link, or other adapter for connection to a wide area network (“WAN”), such as the Internet. Other examples of a network interface include a network adapter for connection to a cellular telephone network, using a 3G, GSM, CDMA, or another such wireless communications standard. The network interface 54 may be incorporated with or peripheral to body scale 12.

In embodiments utilizing a body attachment 20 (as shown in FIG. 1), the body scale 12 can include a second network interface 54 for communicating with a body attachment 20. Via this communication link (e.g., link 28 of FIG. 1), the body scale 12 can receive health measurements acquired by the body attachment 20. This communication link can be a wireless or direct-wired communication link. For example, in some configurations, this communication link is a short-range wireless link (e.g., a Bluetooth link). As such, the body attachment 20 can upload its health measurements to the body scale 12 when the body attachment 20 is in proximity to the body scale 12, such as within 15 feet. Such wireless communication can enable easy and rapid data transmission. In other configurations, this second communication link can be a wired communication link. For example, the body attachment 20 can be connected to the body scale 12 via an electrical connector, such as a USB connector. This wired connection can advantageously charge a battery within the body attachment 20 as data is transmitted between these devices. Additional information about the body attachment 20 will now be provided.

### Body Attachment

Turning again to FIG. 1, specific reference will now be made to the body attachment 20. The body attachment 20 can be an anklet, bracelet, clip, finger ring, toe ring, pendant, necklace, earring or other piercing, implant 22, or other attachable or carry-able device that takes one or more health measurements. These health measurements can include those described in the Health Measurements section below. These health measurements can be taken using one or more sensors 24 and other devices and systems that are described in the Health Measurements section below. Particularly, the body attachment 24 may be used to acquire health measurements that are more difficult to acquire accurately from the feet. For example, in some embodiments, the body attachment 20 can measure the pulse, body temperature, and/or blood pressure of the user 30.

The body attachment 20 can also be configured to measure the activity level of the user. The user's activity level can provide an indication of health and energy consumption. Activity measurements can be acquired using various sensor and devices, which can be coupled to or incorporated into the body attachment 30. For example, in some embodiments, the body attachment includes one or more of an accelerometer, altimeter, pedometer, tilt sensor, magnetometer, and/or a global positioning system (GPS) device. One or more such device can provide three-dimensional movement and activity measurements to the body attachment 20. The user's activity measurements can provide information about the user's sleep habits.

For example, by identifying when a user stops or slows his/her movements, the health measurement system 10 can identify when the user goes to bed, when the user falls asleep, how often the user wakes up during his/her sleep, and when the user wakes up. By analyzing the information, the health measurement system 10 can identify the duration of the user's sleep and the overall quality of the sleep. By combining such sleep measurements from a single day with measurements over a period, the health measurement system 10 can identify the user's sleep behaviors, patterns, or lack of patterns and provide analysis, information, and sleep suggestions to the user 30.

In some embodiments, user's activity measurements can be used to measure the number of calories burned by the user 30 in a day or during a period, such as during a workout. In some embodiments, the health measurement system 10 can utilize body temperature measurements, heart rate measurements, and/or motion measurements to calculate or approximate the user's calorie consumption. These calculations can use the total amount of time a user sleeps in a night and differentiate between calorie consumption levels during the daytime and the nighttime.

In some embodiments, user's activity measurements can be used to track a user's exercise activities, including when a user exercises and the duration of the exercise. This information can be used to recognize if the user 30 is adhering to an exercise program. This information can be automatically be logged onto a chart for the user. This information can also be used to transmit reminders, motivational messages, and congratulations to the user 30.

As mentioned, the body attachment 20 can be electronically coupled to the body scale 12 via a wireless or wired link 28. In some configurations, the health measuring system includes a dock (not shown) or cradle that can receive the body attachment 20 and electronically couple the body attachment 20 to the body scale 12. The dock can include one or more electrical connections, electrodes, or other suitable connectors for electronically coupling the body attachment 20 to the body scale 12. In some instances, the dock can charge a battery of the body attachment 20 while the body attachment is docked.

### Health Measurements

Reference will now be made to the various types of health measurements that can be taken by either the body scale or the body attachment. Reference will also be made to representative sensors or other measuring devices that can be used to take these measurements. It will be understood, the body measuring system can take health measurements using various sensors or devices, including those not described herein.

In some embodiments, the body measuring system can include one or more sensors used to measure various aspects of a user's body and health. For examples, the body scale can include one or more strain gauge sensors. Strain gauge sensors can employ length sensitive electrical resistance technology or another suitable technology. In some instances, two or more strain gauge sensors can be disposed at supportive locations on the body scale to measure a user's weight accurately despite the user's weight distribution on the body scale.

Once body weight is measured, the body measuring system can calculate the user's body mass index (BMI). In some embodiments, this calculation is performed by the controller of the body scale. BMI is based on the user's weight and height, and provides the user with an indication of whether the user is underweight, normal weight, overweight, or obese. BMI is calculated by dividing the user's weight by the square of his/her height. In some configurations, as previously mentioned, the body scale can receive the user's height from an input device. This information can be stored in a memory or a mass storage device. The body measuring system can then calculate the user's BMI each time the user steps of the scale. This information can be provided to the user automatically or upon request.

Because BMI calculations do not differentiate between fat and not-fat body mass, the body scale can be configured to alternatively or additionally provide a body fat percentage (BF %) measurement and/or body water percentage measurement. For example, in some instances, the body scale or body attachment includes two or more electrode pads configured to measure body fat percentage and/or body water percentage. With body scale embodiments, when a user stands barefoot on the two or more electrode pads, a small electric current is sent through the user's body. The electric current is sent from a first electrode, up one leg, across the abdomen and down the other leg to the second electrode. The resistance between the electrodes can be used to determine the measure of body fat and body water, since the resistance can vary between different tissues as fluids in the body. The body measuring system can employ bioelectrical impedance analysis to determine the user's body fat percentage, which is the total weight of the person's body fat divided by the person's weight.

The body measuring system can also use electrode pads or a heart rate monitor to determine a user's heart rate. In some configurations, the heart rate monitor includes an electrocardiogram (ECG or EKG). Heart rate is the number of heartbeats per unit of time (e.g. a minute). Heart rate measurements can assist to determine the level of health of the user and to diagnose and track medical conditions. For instance, healthy or active individuals may have a lower resting heart rate than less active or less healthy individuals. In some configurations, the body measuring system can request that the user be at rest prior to measuring the user's heart rate, to provide a resting heart rate measurement.

In addition to measuring the user's heart rate, the body measuring system can identify any present heart rate abnormalities. For example, the controller of the body scale or the network device can identify arrhythmia, bradycardia, or atrial fibrillation by monitoring the heart rate and regularity. In making these identifications, if the body measuring system identifies that a user's heart rate is to fast the body measuring system can identify or flag a potential arrhythmia condition. If the body measuring system identifies the user's resting heart rate as too slow, such as below beats per minute, the body measuring system can identify or flag a potential bradycardia condition. Additionally, the body measuring system can be configured to identify atrial fibrillation symptoms, in which the user's heart rate is irregular, and which can indicate an increase risk of strokes or other health challenges. When these heart rate irregularities are identified, the body measuring system can provide this information to the user.

In some embodiments, the body measuring system includes a temperature sensor for measuring the user's body temperatures. When disposed on the body scale, the body measuring system can be configured to adjust the measured temperature based on known relationships between feet temperature and average body temperatures because the temperature of the feet can be different from the average body temperature.

In some embodiments, the body measuring system can further includes one or more devices for measuring the user's blood pressure. Blood pressure one of the principle vital signs and can provide useful health information to the user and health professionals. Blood pressure is the pressure that blood exerts upon blood vessel walls within the body. During a heartbeat, blood pressure rises from a diastolic pressure to a systolic pressure, each of which can be measured and tracked by the health measurement system. Healthy users can have lower diastolic and systolic blood pressure values. By providing blood pressure measurements to a user, the user can gauge his/her stress levels and progress in maintaining healthy blood pressure levels. In some embodiments, the body measuring system can measure the user's blood pressure using a pulse oximeter or other suitable device. The pulse oximeter can include one or more light sources (e.g. light-emitting diodes) that transmit light into the skin of a patient. The pulse oximeter can also include one or more detectors, such as a photodetector that detects light reflected from an underlying artery. By processing the character of the reflected and the transmitted lights, the pulse oximeter can identify and measure various features of the user's blood, including the user's blood pressure, oxygen saturation, and more.

Various embodiments of the body measuring system can include devices for measuring the user's blood glucose levels. Blood glucose levels, which indicate the amount of glucose in the blood, can be important information for users with diabetes. For instance, in some configurations, the body measuring system can incorporate an external glucometer that can interface and communicate with the body measuring system. For example, an external glucometer can communicate with one or more components of the body measuring system via a short-range wireless link (e.g., a Bluetooth link). Blood glucose levels can be received, stored, and/or transmitted by the body scale when the external glucometer is located within a minimum range in which the wireless link can be established.

Various embodiments of the body measuring system can include one or more internal or external sensors or other such devices for measuring the user's C-reactive protein levels. C-reactive protein is found the blood and can indicate a rise in inflammation and infection. High levels of C-reactive protein can be problematic to users with heart related diseases. Accordingly, it can be advantageous to monitor the levels of this protein in the blood. In some instances, an external C-reactive protein sensor can communicate with the body measuring system via a short-range wireless link. This information can be received, stored, and/or transmitted by the body scale when the external sensor is located within a minimum range in which the wireless link can be established.

In some embodiments, the health measurement system incorporates one or more additional internal or external sensors that can be used to measure ketone levels within the blood. Ketone bodies include water-soluble compounds that are produced in the liver and kidneys. Ketosis occurs when the blood accumulates an excessive level of ketone bodies. This can be cause by eating disorders and low carbohydrate intake. The measurement of ketone levels can assist the user to recognize if his/her ketone levels are in a healthy range or if ketosis is taking place.

In some embodiments, the health measurement system incorporate one or more additional internal or external sensors that can be used to measure blood cholesterol levels, testosterone levels within the blood, progesterone levels within the blood, and/or drug levels within the blood. These measurements can be useful in providing health and fitness related information to the user and for determining the overall health of the user.

It will be understood that other such health measurements known in the art but not described herein can also be taken by the health measurement system using one or more of the body scale and/or the body attachment.

### Network Services

Referring still to FIG. 1, after the body measuring system 10 has acquired health measurements, these measurements can be transmitted from the body scale 12 to a network device 16, over one or more communication links 32 and a communications network 14, such as the Internet. The wireless communications link includes a cellular communications network utilizing, for example, 3G, GSM, CDMA, or another such wireless communications standard. In other instances, the communications link is a wired communications link utilizing, for example, internet protocol (IP) general packet radio service (GPRS) protocol, or other known communications protocols.

In some embodiments, the network device 16 can provide access the health measurements and related information through a website or mobile applications. The website and mobile application can access information from the network device 16 using a mobile device 18 or computer system 19. These interfaces may display health measurements and provide related information in an easy-to-understand form. The website or mobile application can be secured and require user authentication, such as via a user login prior to providing access to user health measurements and information. The website or mobile application can provide a means whereby the user can input information, such as the user's age, height, health history, and health goals. In some configurations, the website or mobile application can provide an interface for the use to submit the type and amount of food that the user consumed in a day, in order to calculate calorie intake.

Additionally, the website or mobile application can provide various other forms of health related information, tools, logs, charts, advice, and warnings. For example, the website or mobile application can chart the user's weight, body fat percentage, or blood pressure over a period, such as a month or year. In another example, the website or mobile application can chart the user's heart rate, body temperature, and/or calorie consumption during a period of exercise. In yet another example, the website or mobile application can chart the user's sleep measurements during a time while providing analysis and suggestions for improved sleep practices. In still another example, the website or mobile application can provide an overview of the user's health, including warning, areas of cautions, and general tips. The website or mobile application can provide one or more interfaces for recording a user's goals, charting the user's progress, and providing goal related messages, reminders, and encouragement.

In some instances, the network device can be configured to relay the health measurements to a health professional, health insurance organization, physical trainer, or other third party. These individuals may be granted access to the user's health measurements and related information by the user or another party. Using this information, these third parties can track a user's general and specific health and provide feedback or analysis of this information. For instance, a doctor can receive periodic updates of the user's cholesterol levels or blood pressure to track the effects of a prescribed treatment plan. In another instance, a physical trainer can receive periodic updates of the user's weight or body fat percentage and provide exercise program modifications and updates. Furthermore, it will be understood that various other types of tools, features, and information can be provided to the user via the website or mobile application.

Additionally, the website or mobile application can provide various other forms of health related information, tools, logs, charts, advice, and warnings. For example, the website or mobile application can chart the user's weight, body fat percentage, or blood pressure over a period, such as a month. In another example, the website or mobile application can chart the user's heart rate, body temperature, and/or calorie consumption during a period of exercise. In yet another example, the website or mobile application can chart the user's sleep measurements during a time while providing analysis and suggestions for improved sleep practices. The website or mobile application can provide one or more interfaces for recording a user's goals, charting the user's progress, and providing goal related messages, reminders, and encouragement. In still another example, the website or mobile application can provide an overview of the user's health, including providing the user with a score or grade (herein “score”) regarding the user's overall health and wellness, as described in the Body Score section below.

### Body Score

In some embodiments of the present invention, the health measurement system 10 provides the user with an overall health score. The overall health score can give an individual a general sense of his/her overall health. This score can have a significant impact on individuals who considers themselves healthy, but receives a lower score that anticipated. The score can also provide significant motivation to users aspiring to improve their overall health. For instance, when individuals finally achieve a higher overall health score they can have a sense of accomplishment that propels them to continue their improvement.

The overall health score can be given based a set of hierarchical scores, such as the grades A through F, which are used in schools. The score can also be a number, such as 1 through 3, 1 through 5, 1 through 10, 1 through 100, or other such value ranges. The score can also be or include a hierarchical titles, such as Extremely Obese, Obese, Overweight, Normal, Optimal. Similarly, the titles can be laudatory or creative, including terms such as Athlete or Superstar. Accordingly, various different scores ranges and representations can be used. For simplicity, the following description will utilize the score range of 1 through 5, with 5 being the highest, or best, fitness/health level. In some instances, an individual's overall health score takes into account the demographic information of an individual, such as the individual's age and gender.

In some embodiments, the overall health score can be the average of multiple individual scores given to the user's health measurements, such as those previously described. A representative scoring table for various health measurements is shown in Table 1, below.

TABLE 1

| | Body Fat | | | | | | | |
|---|---|---|---|---|---|---|---|---|
| | Percentage | Resting | Systolic | Diastolic | | | | Walk/Run |
| | (Males/ | Heart Rate | Blood | Blood | | | | Ability (with |
| | Females) | (bpm) | Pressure | Pressure | Push-ups | Sit-ups | VO2 | stopping) |
| 1 | 32/38 | 72+ | 180+ | 110+ | 0-5 | 0-20 | 0-35 | Walks less than 3 |
| | | | | | | | | blocks |
| 2 | 25-31/32-37 | 65-72 | 160-180 | 100-110 | 6-10 | 20-30 | 35-39 | Walks between 3 |
| | | | | | | | | blocks and 1 mile |
| 3 | 22-24/29-31 | 60-65 | 140-160 | 90-100 | 11-15 | 31-35 | 40-42.4 | Jogs 1 mile |
| 4 | 19-22/24-28 | 55-60 | 130-140 | 80-90 | 16-30 | 36-50 | 42.5-46.8 | Runs 3 miles |
| 5 | 0-18/0-23 | 0-55 | 0-130 | 0-80 | 31+ | 50+ | 46.9+ | Runs 5 + miles |

As shown in Table 1, an individual's health measurements can be given a score based on the score allocated for the value of each of that person's health measurements. For example, an individual with a resting heart rate of 58 is given a score of four for that health measurement. Similarly, an individual who can do 21 sit-ups is given a score of two for that health measurement. It will be noted, that activity based health measurements such as sit-ups, push-ups, and the ability to walk or run can be based on the individual's ability to perform these activities under preset guidelines, such as performing the activity without stopping and/or without requiring excessive exertion. Once the score for each health measurements is identified, the average of all of the scores can be calculated.

Table 2, which is shown below, illustrates another representative scoring table for various health measurements.

TABLE 2

| | Body Fat | | | | | | | |
|---|---|---|---|---|---|---|---|---|
| | Percentage | Resting | Systolic | Diastolic | | | | |
| | (Males/ | Heart Rate | Blood | Blood | | | Scan | Minutes of Daily |
| | Females) | (bpm) | Pressure | Pressure | Push-ups | Sit-ups | Score | Aerobic Activity |
| 1 | 32/38 | 72+ | 180+ | 110+ | 0-5 | 0-20 | 0-20,00 | 0-5 |
| 2 | 25-31/32-37 | 65-72 | 160-180 | 100-110 | 6-10 | 20-30 | 20,000-30,000 | 5-15 |
| 3 | 22-24/29-31 | 60-65 | 140-160 | 90-100 | 11-15 | 31-35 | 30,000-40,000 | 15-30 |
| 4 | 19-22/24-28 | 55-60 | 130-140 | 80-90 | 16-30 | 36-50 | 40,000-50,000 | 30-50 |
| 5 | 0-18/0-23 | 0-55 | 0-130 | 0-80 | 31+ | 50+ | 50,000+ | 50+ |

As shown in Table 2, an individual's health measurements can be given a score based on the score allocated for the value of each of that person's health measurements. Scoring for BFP, heart rate, blood pressure, push-ups, and sit-ups can be the same as those shown in Table 1. However, the VO2 category is replaced with a Scan Score category, and the Walk/Run ability category is replaced with a category that scores the number of minutes an individual spends daily engaged in aerobic activity. The scan score can be a score determined by a scanner that measures carotenoid antioxidant activity, such as the Pharmanex Biophotonic Scanner from NuSkin, Inc. As with the scoring table of Table 1, once the score for each health measurements is identified, the average of all of the scores can be calculated.

It will be understood, that Tables 1 and 2 are provided as a representative tables, and individual scores for the listed body measurements can be changed. However, a similar score table can be created for each health measurement used in the calculation of the overall health score with scores given based on the scoring hierarchy. Furthermore, in some embodiments, the health measurements used in the scoring table can vary from those shown in Tables 1 and 2. The set of health measurements used in scoring an individual's overall can include various health measurements that can collectively represent the overall health of an individual. For example, an overall health score can be an average of a large body of individual measurements, including, but not limited to, heath measurements relating to a user's fitness, blood content, weight and fat percentage, flexibility, heart health, and/or lung capacity. The average overall health score can be rounded to the nearest score. In some instances, there is no level zero scores, but the lowest score begins at level one. In some instances, individuals can assess their non-rounded score if they wants to know how close they are to achieving the next score level.

In some instances, some health measurements or combinations of health measurements may be given greater weight than others may. For example, low scores in both blood cholesterol content and blood pressure may automatically bring an individual's score down at least one level, regardless of their affect of the average score. Similarly, other blood content levels that indicate illness or disease can automatically lower an individual's score at least level. On the other hand, some scores with greater weight than others can automatically increase the level of a user's overall health score.

Additionally, category health scores can be provided for various health categories, which include a set of related health measurements. Health categories can include, for example, fitness, blood content, flexibility, weight, and/or heart health. Representative health measurements in a fitness category can include the user's ability to perform given number of push-ups, sit-ups, pull-ups, chin-ups, or other known or developed exercise. Representative blood content health measurements can include blood glucose levels, C-reactive protein levels, ketone levels, oxygen saturation levels, cholesterol levels, testosterone levels, progesterone levels, alcohol levels, drug levels, and other such measurements. Representative flexibility health measurements can include the degree of flexibility based on a sit-and-reach test, a V-sit test, a groin flexibility test, a calf muscle flexibility test, a trunk rotation test, a shoulder rotation test, a shoulder flexion test, and other know or developed flexibility tests. Representative weight health measurements can include an individual's height, weight, body mass index, and/or body fat content. Representative heart health measurements can include an individual's resting heart rate, systolic blood pressure, diastolic blood pressure, and/or the presence or absence of heart rate irregularities.

In some embodiments, the overall health score, average health score of various health categories, and/or individual health scores are presented via the previously mentioned website, mobile application, and/or body scale. In some instance, only the overall health score is presented. In other instances, the individual is presented with a report card type format, including scores in each of two or more health categories and the overall health score. In other instance, all health measurements and corresponding scores are presented along with an overall health score.

In some instances, the overall health score can be accompanied by tips, advice, educational material, and/or other information that informs the individual on how to improve his/her overall health score. For instance, this information can identify certain scores that are dragging down the individual's overall health score and suggest ways in which the individual can improve those specific scores. As such, the overall health score can focus a person's attention not only on fitness, diet, or weight, but also on all aspects of his/her health.

It will be understood, that the present systems and methods for providing an overall health score may be practiced by one or more computing devices and in a variety of system configurations, including in a networked configuration. The methods and processes of the present invention can be particularly useful in association with a system comprising a networked computer system, such as a website server or database, or a mobile computer or other handheld device. Similarly, embodiments of the present invention can include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the systems and methods for providing an overall health score may embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include those previously mentioned. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

Representative system for implementing embodiments of the systems and methods for providing an overall health score may includes computer device, which may be a general-purpose or special-purpose computer or any of a variety of consumer electronic devices. For example, computer device may be a personal computer, a notebook computer, a netbook, a smart phone or other hand-held device, a workstation, a server, a mainframe, a multi-processor system, a network computer, a processor-based consumer electronic device, or the like. Representative systems can include a system bus, processor or controller, and memory, one or more mass storage devices, and other such components, as previously mentioned.

From the foregoing, it will be seen that the he measurement and presentation of the users' health measurements and information can provide users with the tools to manage their weight and overall health. This system can avoid the downsides of temporary health fads by offering actual, measurable information that can be used to form enduring, effective, and improved lifestyle changes. This information can empower users to managing their weight, eat properly, and maintaining an active lifestyle in order to reduce their propensity to illness and disease and prolong their life expectancy.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for scoring an individual's overall health and wellness, the method comprising:
receiving one or more health measurements of an individual, the one or more health measurements including the individual's resting heart rate, the individual's blood pressure, and the individual's body fat percentage; and
calculating a health score of the individual based on the receive health measurements.

2. The method of claim 1, further comprising receiving demographic information from an individual, the demographic information including the individual's age and gender, and wherein in calculating a health score is based on the received demographic information.

3. The method of claim 1, wherein the health score is a selected from a set of hierarchical scores, the set of hierarchical scores including between three and ten hierarchical scores.

4. A health measurement system comprising:
a body scale and body attachment configured to measure one or more health measurements from an individual, the one or more health measurements including the individual's resting heart rate, the individual's blood pressure, and the individual's body fat percentage; and
a network device electronically coupled to the body scale through one or more electronic communication links, the network device being configured to receive the one or more health measurements from the body scale and calculate a health score of the individual based on the receive health measurements.

5. The health measurement system of claim 4, wherein the health score is a selected from a set of hierarchical scores, the set of hierarchical scores including between three and ten hierarchical scores.

6. A health measurement system comprising a body scale and body attachment configured to measure one or more health measurements from an individual, the one or more health measurements including the individual's resting heart rate, the individual's blood pressure, and the individual's body fat percentage, the body scale being configured to calculate a health score of the individual based on the receive health measurements.

7. The health measurement system of claim 6, wherein the health score is a selected from a set of hierarchical scores, the set of hierarchical scores including between three and ten hierarchical scores.
